(19) United States
(12) Patent Application Publication
(10) Pub. No.: US 2015/0214705 A1
(43) Pub. Date: Jul. 30, 2015

(54) Conduit Code Bands

(71) Applicant: AJ Solutions, Inc., La Center, WA (US)

(72) Inventors: Aaron Dowler, Vancouver, WA (US); Joseph Jones, LaCenter, WA (US)

(73) Assignee: AJ SOLUTIONS, INC., La Center, WA (US)

(21) Appl. No.: 14/605,081

(22) Filed: Jan. 26, 2015

Related U.S. Application Data
(60) Provisional application No. 61/965,314, filed on Jan. 27, 2014.

(51) Int. Cl. H02G 3/04

(52) U.S. Cl. CPC H02G 3/0406; H02G 2200/20

(57) ABSTRACT

Conduit code bands for the marking of electrical conduits, each with a color identifying what kind of system is in that conduit. Each conduit code band comprising a wall of flexible material, cylindrical in shape with an opening on one side of the wall, a finger ridge on the wall, one or more rounded ends on the wall adjacent the opening, one or more interlocking bumps on a top side of the one or more rounded ends, and one or more interlocking notches on a bottom side of the one or more rounded ends.

### CROSS-REFERENCE TO RELATED APPLICATION

This application is a continuation of and claims priority to co-pending Provisional Application Ser. No. 61/965,314, filed 27 Jan. 2014, incorporated herein by reference.

### FIELD OF THE INVENTION

The present invention relates to the marking of electrical conduits. More particularly, it relates to systems that identify what kind of system is in a conduit, such as building fire alarm systems, grounding, telecom/data, voice evacuation and etc.

### BACKGROUND

Markings are usually required on electrical conduit every 10 ft depending on customer's specs so the conduit can be tracked more easily throughout the building. You can find this type of marking methods at hospitals, universities, power plants, paper mills, chip plants and many other commercial and industrial locations. The traditional way of marking electrical conduits has been to attach sticky colored electrical tape to the conduits. Not all facilities use the same colors when marking their conduits and typically each facility has its own color coding for marking. Fire alarm systems use the color red and that is the only color that is set by the national electrical code.

The prior art solutions are not adequate. Wrapping the conduit with bands of colored tape can be a pain sometimes. For example, tearing pieces of tape off with one's fingers makes for sore fingers after a while. Trying to wrap tape around and between conduits isn't as easy as it looks—wrapping colored tape takes time to get the wrap straight around the conduit, especially when the conduits are close together. When there are exposed conduits in a facility or factory, it is desirable to have everything looking neat and tidy.

### SUMMARY

The present invention comprises specialized components for the marking of electrical conduits, identifying what kind of system is in that conduit, such as building fire alarm systems, grounding, telecom/data, voice evacuation and so on. The conduit code bands described herein are able to be used on EMT or electrical metallic tubing, IMC or intermediate metal conduit, RMC or rigid metal conduit, PVC or poly-vinyl chloride and any other aspects of conduits covered by the national electrical code. With conduit code bands, one can press the colors right on the conduits no matter how close or apart they are, and if the conduit runs on the surface of a wall—they will snap on just as easy. Conduit code bands come in many different sizes ½″, ¾″, 1″, 1¼″, 1½″, 2″, 2½″, 3″, 3½″, 4″, 5″, 6″. Conduit code bands come in ¾″ and ⅜″ widths depending on if it's a single or two color coded run

And with these advantages, this marking process will save lots of time and money for the electrical companies and makes it a lot easier to install for the end users.

The present invention overcomes a few problems associated with the prior art, more specifically, conduit code bands are made of pvc or polyvinyl chloride and can come in any color options you want over the prior art (colored vinyl electrical tape). The present invention also has the ability to snap onto the conduits quick and easy as well as looking perfect every time it's snapped on in an instant. With the prior art, you have to wrap and rewrap the tape trying to give it that professional look you need especially in exposed areas around the electrical panel. Another important advantage the present invention has over the prior art is the cleanliness, the conduit codes are super clean and has no sticky residue that the prior art has. There are some companies such as chip factories or food processing plants where dust particles are not allowed and have strict protocol levels that need to be maintained throughout the production.

Another advantage the conduit codes have over the prior art is that there are two widths you can make the colors, the first width is a standard width ¾′″ the same as colored vinyl electrical tape and the other width is ⅜″ wide. The ⅜″ wide conduit code can be used on a two colored marking system so that two colors can fit onto a conduit or pipe fitting such as a connector or coupling. With this advantage you can mark all the fittings first at a table before installing conduit off of a ladder or scissor lift, making it more convenient to complete the task. The ¾″ width conduit codes for a single color can be used on the fittings as well.

### BRIEF DESCRIPTION OF THE DRAWINGS

The accompanying drawings, which are incorporated into and constitute a part of this specification; illustrate one or more embodiments of the present invention and, together with the detailed description, serve to explain the principles and implementations of the invention.

FIG. 1 shows a top view of an embodiment of a first embodiment of a conduit code band.

FIG. 2 shows a side-view of the first embodiment of a conduit code band.

FIG. 3 shows a front perspective view of the first embodiment of a conduit code band.

FIG. 4 shows a bottom-view of the first embodiment of a conduit code band.

FIG. 5 shows a front-side perspective view of the first embodiment of a conduit code band.

FIG. 6 shows a front-top perspective view of the first embodiment of a conduit code band clipped on a conduit.

FIG. 7 shows a front-top perspective view of a second embodiment of the invention, with a first conduit code band and a second conduit code band of different colors on a conduit fitting.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but they may.

The description may use perspective-based language such as up/down, back/front, and top/bottom. Such language is merely used to facilitate the discussion, showing relative orientation and location of components to one another and is not intended to restrict the application of embodiments of the present invention to particular orientations.

### First Embodiment

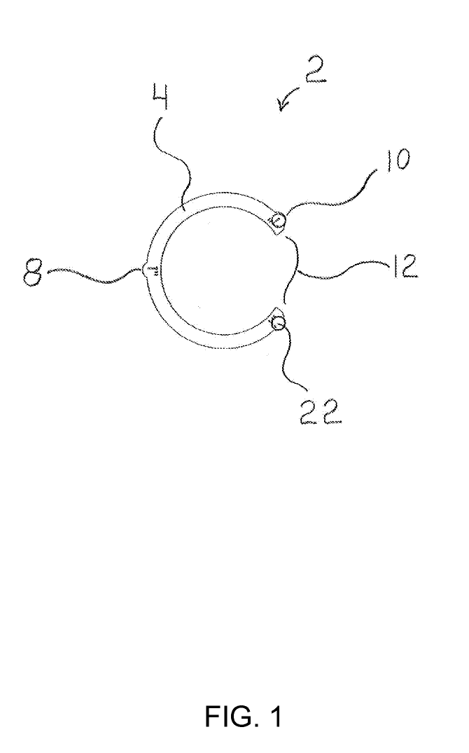

FIGS. 1-6 show a first embodiment of a conduit code band 2. In the first embodiment, the conduit code band 2 is ¾″ wide but in other embodiments may have other suitable widths. The conduit code band 2 includes a wall 4 of specific thickness so that the conduit code band 2 has just the right memory and spring back effect to operate successfully. The conduit code band 2 may be made of polyvinyl chloride (pvc), or chlorinated polyvinly chloride (cpvc), or some other suitable material with similar properties. These materials work well for the environments in which the conduit code bands 2 will be installed and can be made in any color. The color of a particular conduit code band 2 indicates the type of electrical systems that is ran in a conduit 14 to which the conduit code band 2 is attached.

The conduit code band 2 may also have a size marking 6 stamped in the material for size identification so that the correct conduit code band 2 can fit on the correct conduit 14. These conduit code bands 2 may also have a finger ridge 8. The finger ridge 8 may be a back side of the conduit code band 2 opposite an opening 12. The finger ridge 8 may be rounded or non-rounded The finger ridge 8 helps with adjusting the position and orientation of the conduit code band 2 once it is snapped on to the conduit 14.

The conduit code bands 2 also may have rounded ends 10. The rounded 10 ends allow the conduit code band 2 to spread while being pressed onto the conduit 14, widening the opening 12 so a user don't have to physically spread the conduit code band 2 apart with their fingers.

The conduit code band 2 is specially designed with a specific gap or opening 12. The gap or opening 12 will be different on each size of conduit code band 2. The opening 12 is sized and shaped not to interfere with a surface where the conduit 14 is secured to the surface.

The conduit code band 2 may have a set of interlocking bumps 22 and a set of interlocking notches 24 (or slots). The interlocking bumps 22 and the interlocking notches 24 are used for locking two conduit codes 2 together when using a two color coding system. The interlocking bumps 22 are located on tops of the rounded ends 10 of the conduit code 2 near the gap or opening 12 and the interlocking notches 24 are located on bottoms of the rounded ends 10.

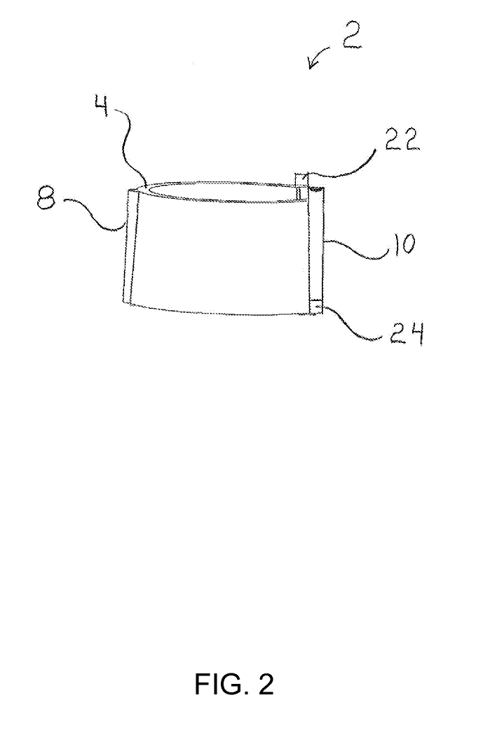

FIG. 2 shows the conduit code band 2 and the wall 4 specific thickness for just the right spring back and memory function of the conduit code band 2. The finger ridge 8 that helps with the alignment and adjustment of the conduit code band 2 after it's attached to the conduit 14 is visible along with the rounded ends 10 to help snap the conduit code band 2 on to the conduit 14 and the specially designed gap or opening 12 of the conduit code band 2. The interlocking bumps 22 is also seen along with the interlocking notches 24 that allows the interlocking bumps 22 to fit into when using a two color coding system.

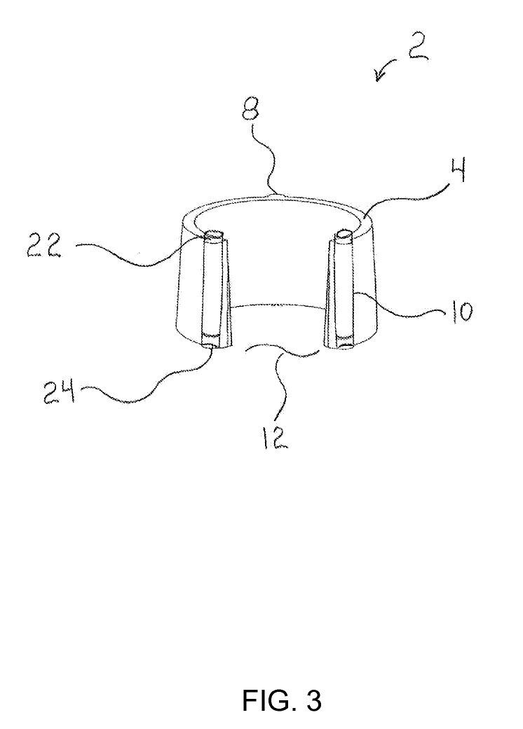

FIG. 3, shows a view of the specially designed gap or opening 12 of the conduit code band 2, as well as the rounded ends 10. On the back side of the conduit code band 2, the finger ridge 8 can be seen. The interlocking bumps 22 can be seen as well as the interlocking notches 24 and the wall 4 of specific thickness.

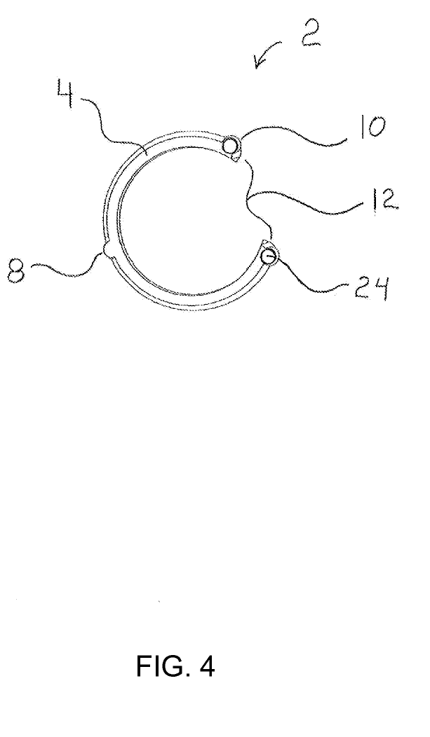

FIG. 4, shows a view of the specially designed gap or opening 12 of the conduit code band 2, as well as the rounded ends 10. The finger ridge 8 can be seen along with the interlocking notches 24 and the wall 4 of specific thickness 4.

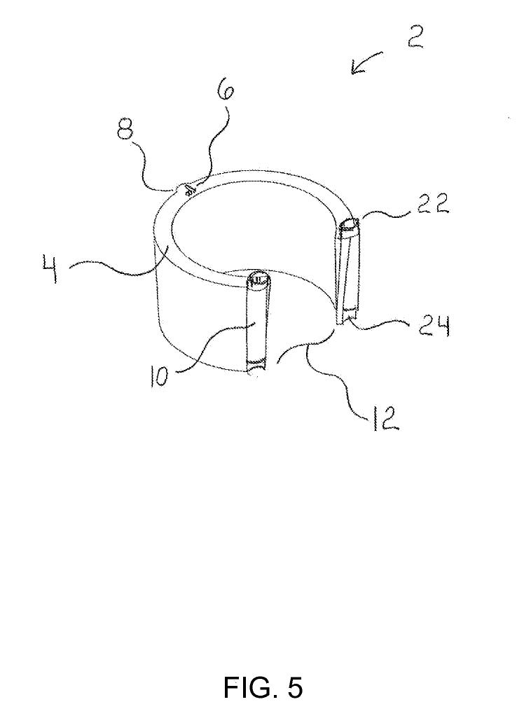

FIG. 5 shows the conduit code band 2 and the specially designed gap or opening 12 and at each end of the opening 12 are the rounded ends 10. In this figure, one can see how these rounded ends 10 work when snapping the conduit code band 2 on to the conduit 14. At the ends 10 of the conduit code band 2 and where the finger ridge 8 is located, you can clearly see the size markings 6, the interlocking bumps 22 with the interlocking notches 24 and the wall 4 of specific thickness 4 allowing the conduit code band 2 to have just the right spring back and memory.

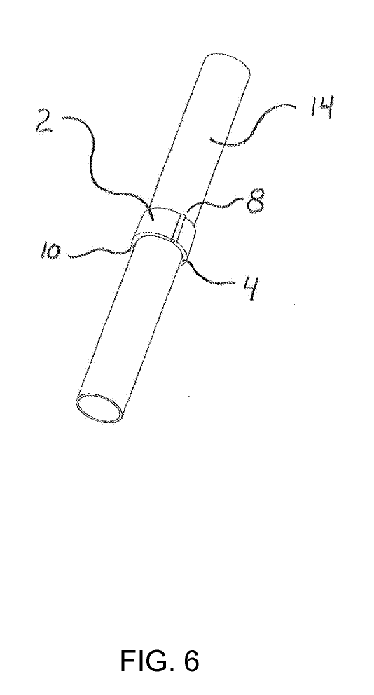

FIG. 6 shows the conduit code band 2 and how it fits on the conduit 14. One can also see the finger ridge 8 and the wall 4 of the conduit code band 2. The conduit code 2 rounded end 10 is visible as well.

### Second Embodiment

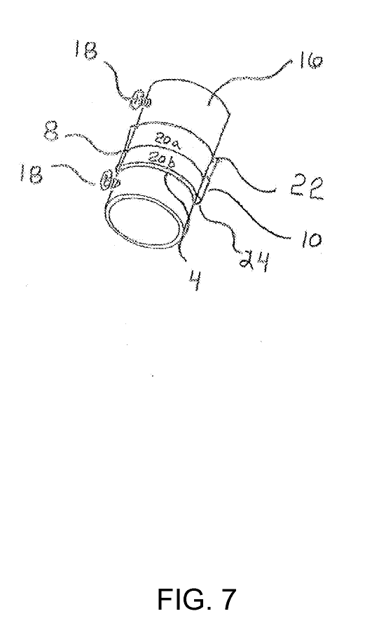

FIG. 7 shows a second embodiment of the invention which facilitates two color coding. The second embodiment has a first conduit code band 20a and a second conduit code band 20b, both ⅜″ wide. The first conduit code band 20a and the second conduit code band 20b are shown coupled to a conduit fitting 16. Both the first conduit code band 20a and the second conduit code band 20b fit between two set screws 18 of the conduit fitting 16. The first conduit code band 20a has one color and the second conduit code band 20b has a different color. Together these combined colors of the first conduit code band 20a and the second conduit code band 20b can identify a single system that is in that conduit 14. As shown in FIG. 7 the first conduit code band 20a and the second conduit code band 20b of the second embodiment also have the same elements that the conduit code bands 2 of the first embodiment have, such as the finger ridge 8, rounded ends 10, the wall 4, size markings 6, the specific gap or opening 12 along with the interlocking bumps 22 and the interlocking notches 24.

A specific color coding scheme from a microchip fabrication plant is shown in a table below, but other color coding scheme may be used.

| SYSTEM | COLORS |
|---|---|
| 120/208 V NORMAL POWER | BLACK |
| 120/208 V EMER. POWER | BLACK/ORANGE |
| 277/480 V NORMAL POWER | BLUE |
| 277/480 V EMER. POWER | BLUE/ORANGE |
| GROUNDING | GREEN |
| BUILDING FA SYSTEM | RED |
| VOICE EVACUATION | ORANGE |
| TELECOM/DATA | YELLOW |
| FMS AND CONTROL CIRCUITS | BLUE/BLACK |
| CCTV | WHITE |
| MONITORING/SECURITY | GREY |
| GAS DETECTION | RED/BLACK |
| COMETS | RED/WHITE |
| GENERAL CONTROLS | BROWN/WHITE |
| MEDIUM & HIGH (VOLTAGE) | PURPLE |

Although specific embodiments have been illustrated and described herein, it will be appreciated by those of ordinary skill in the art and others, that a wide variety of alternate and/or equivalent implementations may be substituted for the specific embodiment shown and described without departing from the scope of the present invention. This application is intended to cover any adaptations or variations of the embodiment discussed herein. Therefore, it is manifested and intended that the invention be limited only by the claims and the equivalents thereof.

What is claimed is:

1. A conduit code band comprising:
a wall of flexible material, cylindrical in shape;
an opening on one side of the wall;
a finger ridge on the wall;
one or more rounded ends on the wall adjacent the opening;
one or more interlocking bumps on a top side of the one or more rounded ends; and
one or more interlocking notches on a bottom side of the one or more rounded ends.

2. The conduit code band of claim 1,
wherein the finger ridge is on the wall opposite the opening.

3. The conduit code band of claim 1,
wherein the wall is ¾inches wide.

4. The conduit code band of claim 1,
wherein the wall is ⅜ inches wide.

5. The conduit code band of claim 1, further comprising:
a size marking on the wall.

6. The conduit code band of claim 1,
wherein the wall is of a material and a thickness that allows the opening to spread around a conduit with a diameter similar to that of the wall of the conduit code band when the conduit code band is pushed against the conduit.

7. A conduit code band system comprising:
a first conduit code band and a second conduit code band, each with:
a wall of flexible material, cylindrical in shape,
an opening on one side of the wall,
a finger ridge on the wall,
one or more rounded ends on the wall adjacent the opening,
one or more interlocking bumps on a top side of the one or more rounded ends, and
one or more interlocking notches on a bottom side of the one or more rounded ends; and
wherein the first conduit code band has a first color and the second conduit code band has a second color.

8. The conduit code band of claim 7,
wherein the finger ridge is on the wall opposite the opening.

9. The conduit code band of claim 7,
wherein the wall is ⅜ inches wide.

10. The conduit code band of claim 7, further comprising:
a size marking on the wall.

11. The conduit code band of claim 7,
wherein the wall is of a material and a thickness that allows the opening to spread around a conduit with a diameter similar to that of the wall of the conduit code band when the conduit code band is pushed against the conduit.
